(19) United States
(12) Patent Application Publication
(10) Pub. No.: US 2014/0321535 A1
(43) Pub. Date: Oct. 30, 2014

(54) METHOD AND APPARATUS FOR CONTROLLING VIDEO BITRATE

(71) Applicant: CORE LOGIC INC., Seoul (KR)

(72) Inventor: Seong-Hee KIM, Seoul (KR)

(73) Assignee: CORE LOGIC INC., Seoul (KR)

(21) Appl. No.: 14/259,377

(22) Filed: Apr. 23, 2014

(30) Foreign Application Priority Data
Apr. 26, 2013 (KR) 10-2013-0046895

(51) Int. Cl. H04N 19/115; H04N 19/172; H04N 19/159; H04N 19/14

(52) U.S. Cl. CPC H04N 19/0006; H04N 19/00157; H04N 19/00266; H04N 19/00218
USPC 375/240.03

(57) ABSTRACT

The present invention may improve image quality of a video image while maintaining fixed bitrates by discrete cosine transforming a pixel value a current frame from a video signal, calculating a complexity of a current frame based on a transform coefficient value of a current frame according to the discrete cosine transform, obtaining a quantization parameter of a current frame using the complexity of a current frame, and controlling bitrates of a video image.

### CROSS-REFERENCE TO RELATED APPLICATION

This application claims priority to Korean Patent Application No. 10-2013-0046895 filed on 26 Apr. 2013, and all the benefits accruing therefrom under 35 U.S.C. §119, the contents of which is incorporated by reference in its entirety.

### BACKGROUND

1. Technical Field The present invention relates to method and apparatus for controlling video bitrate, and more specifically method and apparatus for controlling bitrate in video encoders.

2. Background Art

When performing methods for removing temporal redundancies and spatial redundancies, that is, intra or inter prediction, technologies such as discrete cosine transform and quantization, etc. are used to increase compression rates of image signals.

### BRIEF SUMMARY

An objective of the present invention is to efficiently control video bitrate taking complexity of a video image into consideration.

To achieve the objective of the present invention, the present invention provides a method and an apparatus for controlling video bitrate taking complexity of a video image based on a transform method into consideration.

The present invention provides a method and an apparatus for controlling video bitrate defining complexity of a video image as a number of alternating components or an average value of alternating components from a transform coefficient value.

The present invention provides a method and an apparatus for controlling video bitrate performing discrete cosine transform taking prediction type of a present frame into consideration.

The present invention provides a method and an apparatus for controlling video bitrate allocating target bit count of a present frame based on complexity of a prior frame.

In accordance with the present invention, a precise target bit count may be predicted by defining complexity of a video image based on a transform method, and accordingly, image quality of a video image may be improved even while maintaining fixed bit rates.

### BRIEF DESCRIPTION OF THE DRAWINGS

FIG. 1 is a block diagram of a video signal encoding device (100) in accordance with an embodiment of the present invention.

FIG. 2 is a block diagram of a bitrate control unit (125) in accordance with an embodiment of the present invention.

FIG. 3 is a flow chart illustrating a process obtaining a quantization parameter of a present frame using complexity based on a transform method in accordance with an embodiment of the present invention.

FIG. 4 is a flow chart illustrating a process calculating a target bit count of a current frame in accordance with an embodiment of the present invention.

### DETAILED DESCRIPTION

Hereinafter, preferred embodiments of the invention will be described in detail with reference to accompanying drawings

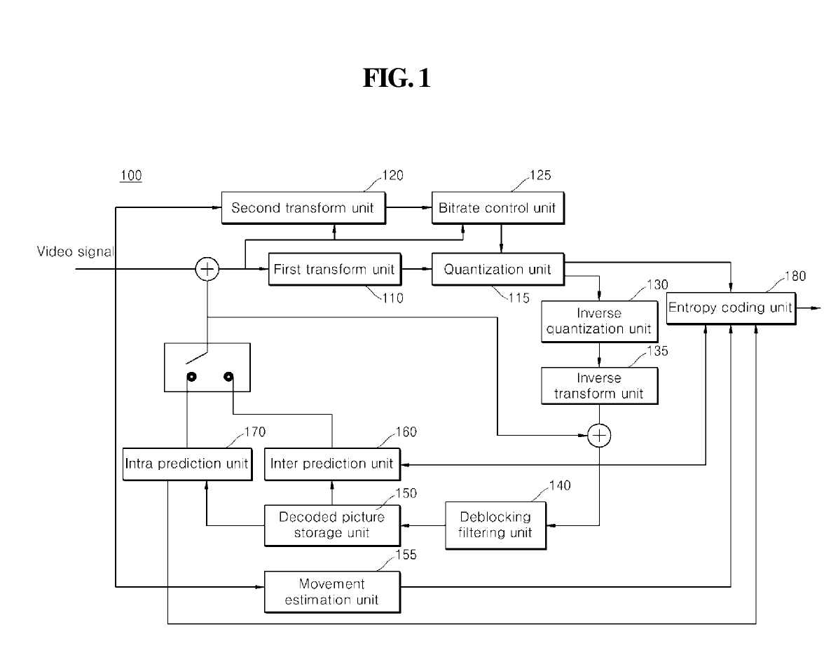

FIG. 1 is a block diagram of a video signal encoding device (100) in accordance with an embodiment of the present invention.

Referring to FIG. 1, a video signal encoding device (100) may comprise a first transform unit (110), a quantization unit (115), a second transform unit (120), a bitrate control unit (125), an inverse quantization unit (130), an inverse transform unit (135), a deblocking filtering unit (140), a decoded picture storage unit (150), a motion estimation unit (155), an inter prediction unit (160), an intra prediction unit (170), and an entropy coding unit (180).

A first transform unit (110) obtains a transform coefficient value by transforming residual data, and a discrete cosine transform or a wavelet transform method may be used in this instance. The residual data may be a differential data between an original frame and a predictive frame. The predictive frame may be generated by intra prediction and/or inter prediction. A quatization unit (115) quantizes a transform coefficient value outputted from a transform unit (110). A second transform unit (120) may obtain a transform coefficient value by transforming pixel values of an original frame. Similarly, a discrete cosine transform or a wavelet transform method may be used. A bitrate control unit (125) may control a bitrate allocated in units of Group of Picture (GOP), a frame, or a macro block This is examined by referring to FTC. 2. An inverse quantization unit (130) inverse quantizes a transform coefficient value, and an inverse transform unit (135) restores an inverse quantized transform coefficient value to residual data. A deblocking filtering unit (140) is applied to each coded macro block to reduce block distortion. A deblocking filtered picture is stored in a decoded picture storage unit (150) for use as a reference picture. A movement estimation unit (155) searches for a reference block that is the most similar to a present block from a reference picture, and transmits location information of the searched reference block, etc. to an entropy coding unit (180). An inter prediction unit (160) performs prediction of a present picture using a reference picture, and transmits encoding information of an inter prediction to an entropy coding unit (180). An intra prediction unit (170) performs intra prediction from a decoded pixel in a present picture, and transmits encoding information of an intra prediction to an entropy coding unit (180). An entropy coding unit generates a video signal bitstream by entropy coding a quantized transform coefficient value, an encoded information of an inter prediction, an encoded information of an intra prediction, a reference block information, etc. inputted from a movement estimation unit (160).

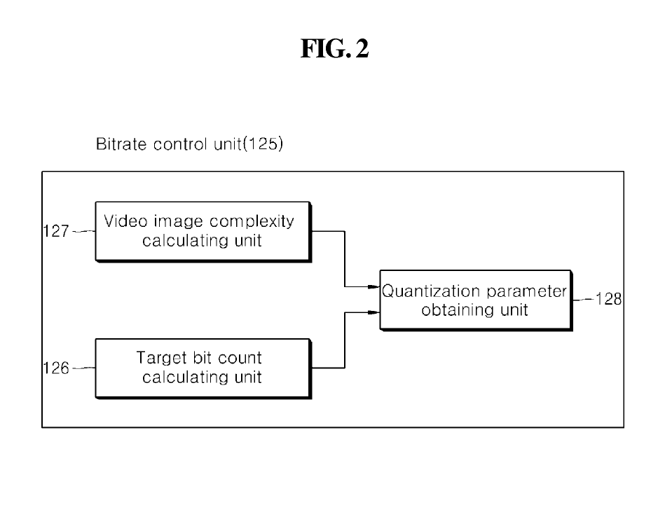

FIG. 2 is a block diagram of a bitrate control unit (125) in accordance with an embodiment of the present invention.

Generally, an output bitstream of a video encoder uses a constant bit rate (CBR) or a variable bit rate (VBR). A constant bit rate method is a method encoding in constant number of bits for a fixed time, and image quality may worsen in cases where there are large movements or complex images, and may be used when bandwidths are limited. On the contrary, a variable bit rate method is a method encoding in constant image qualities regardless of image characteristics, and may be used when there are sufficient bandwidth or when using storage media such as DVD (Digital Video Disks), etc. A bitrate control method is used to encode in constant number of bits in the constant bit rate method, and a bitrate may be controlled using a quantizing parameter. For example, a relatively large quantizing parameter is used to lessen bit counts, and a relatively small quantizing parameter is used to increase bit counts.

Referring to FIG. 2, a bitrate control unit (125) may comprise a target bit count calculating unit (126), a video image complexity calculating unit (127), and a quantization parameter obtaining unit (128).

A target bit count calculating unit (126) may calculate the total number of bits that may be used when a frame is encoded. A video image complexity calculating unit (127) may calculate a complexity of a video image using a transform coefficient value outputted from a second transform unit (120). A quantization parameter obtaining unit (128) may obtain a quantization parameter to be applied to a current frame by using target bit counts of a frame in a current picture group (hereinafter, referred to a current frame) outputted from the target bit count calculating unit (126) and a complexity of a current frame outputted from the video image complexity calculating unit (127).

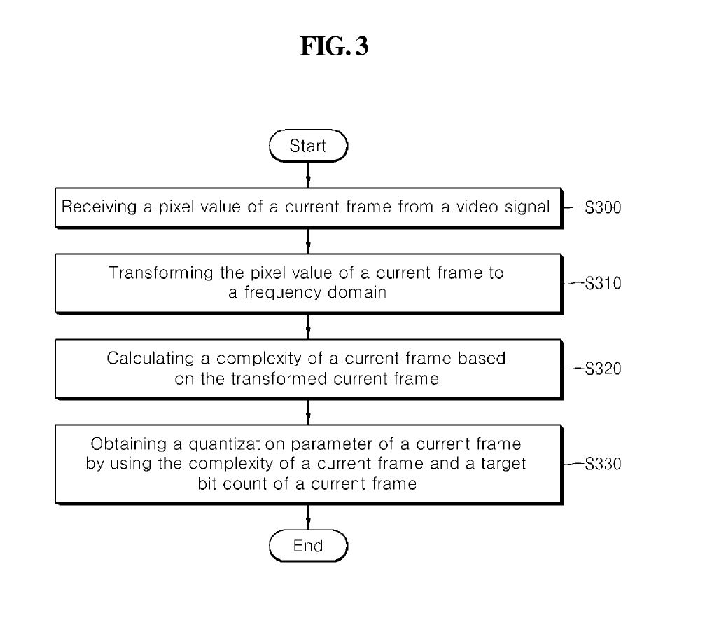

FIG. 3 is a flow chart illustrating a process obtaining a quantization parameter of a present frame using complexity based on a transform method in accordance with an embodiment of the present invention.

Referring to FIG. 3, a second transform unit (120) may transmit a pixel value of a current frame from a video signal (S300). The second transform unit (120) may transform a pixel value of the current frame to a frequency domain (S310). In this case, a discrete cosine transform method may be used. That is, a discrete cosine transform method is a transform used to express an original image as a frequency component. Therefore, a frequency component value obtained from a discrete cosine transform may be restored to an original pixel value by inverse transforming. A result value from a discrete cosine transform, that is, a transform coefficient value comprises direct components and alternating components. Direct components are coefficients of a state where frequency is 0, and components other direct components are alternating components changing in all frequencies from low frequencies to high frequencies. The discrete cosine transform may be performed in at least one block in the current frame. That is, it may be performed in all blocks in the current frame, and it may be performed selectively according to a portion of blocks in the current frame.

And, a discrete cosine transform corresponding to the current frame may be performed by taking a prediction type of a current frame into consideration. A prediction type of a current frame may be information showing whether a current frame is an intra frame or an inter frame. For example, a discrete cosine transform may be limited to cases in which the current frame is an intra frame. A discrete cosine transform may be performed regardless of prediction types of a current frame.

A video image complexity calculating unit (127) may calculate a complexity of a current frame based on pixel values of the transformed current frame (S320). Relatively greater bit counts are required for images with greater complexities. A complexity of the current frame may be expressed from number of alternating components, average value of alternating components, etc. from transform coefficient values.

A quantization parameter obtaining unit (128) may obtain a quantization parameter of a current frame by using a complexity of the transformed current frame and a target bit count of the current frame (S330). That is, bit counts, which are used for coding a current frame, may be controlled by obtaining a quantization parameter taking a complexity of a current frame into consideration. For example, a relatively large quantization parameter should be used as complexities of a current frame becomes greater to satisfy allocated target bit counts for a current frame. On the contrary, a relatively small quantization parameter should be used as complexities of a current frame becomes lesser to satisfy allocated target bit counts for a current frame.

Therefore, target bit count, complexity, and quantization parameter may be modeled as equation 1, and the equation 1 may be used to obtain a quantization parameter of a current frame.

T_{c}=x*(S_{c}/Q_{c}) [Equation 1]

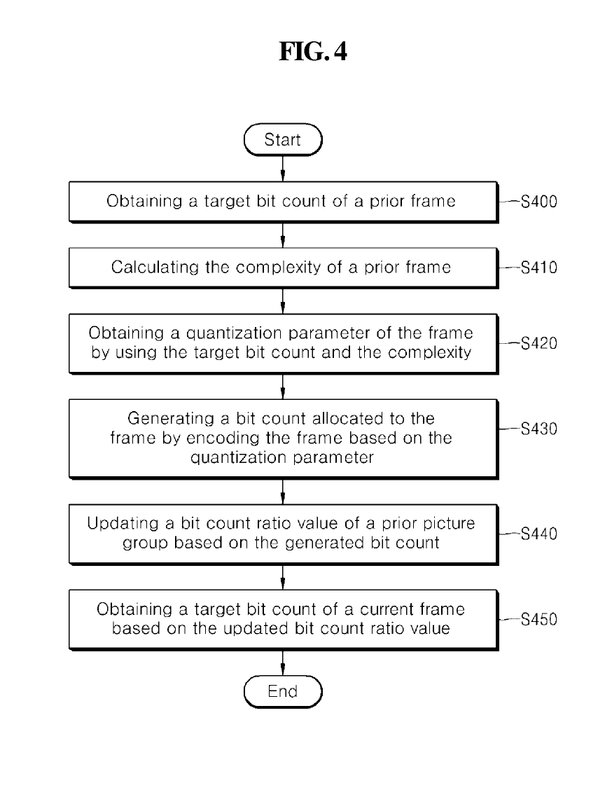

In the equation 1, T_{c} is a target bit count for a current frame, S_{c} is a complexity of current frame, Q_{c} is a quantization parameter for a current frame, and x is a model parameter. A target bit count for the current frame may be predicted based on a complexity of a prior frame, and is examined referring to FIG. 4.

The obtained quantization parameter of a current frame is transmitted to a quantization unit (115), and residual data of a current frame may be quantized by using the quantization parameter.

FIG. 4 is a flow chart illustrating a process calculating a target bit count of a current frame in accordance with an embodiment of the present invention.

Referring to FIG. 4, a target bit count calculating unit (127) may obtain a target bit count of a frame in a prior picture group (hereinafter, referral to as a prior frame) (S400). The prior frame may have identical prediction type of a current frame. For example, in the case a current frame in a current picture group is an intra frame, the prior frame also may be an intra frame, and in the case a current frame in a current picture group is an inter frame, the prior frame also may be an inter frame. In the case when multiple inter frames exist in a prior picture group, a target bit count of an inter frame temporally closest to a current frame may be used.

Also, a target bit count may be obtained by applying weights to target bit counts allocated to each multiple inter frames. For example, a target bit count of the prior frame may be obtained as an average value of target bit counts allocated to each multiple inter frames. Or the weights may be determined by taking temporal differences between a current frame and a prior frame into consideration, and in this case, a sum of weights applied to each multiple inter frames may satisfy one.

A video image complexity calculating unit (126) may calculate a complexity of the prior frame (S410), and a quantization parameter obtaining unit (128) may obtain a quantization parameter of a prior frame by using a target bit count of the prior frame and a complexity of the prior frame (S420). A complexity of a prior frame and a quantization parameter may be obtained by an identical method of method described in FIG. 3, and detailed description is skipped.

A quantization unit (115) may generate bit counts used in a prior frame by encoding a prior frame based on a quantization parameter of the prior frame (S430).

A target bit count calculation unit (127) may update a bitrate ratio value of a prior picture group based on the generated bit count (S440).

This is to make a target bit count allocated to a current frame relatively greater on condition that a prior frame is similar to a current frame when a bit count used to encode a prior frame is greater than a target bit count of a prior frame.

The bit count ratio value may be a ratio of bit counts used in an intra frame and an inter frame in a picture group unit. For example, a bit count ratio value of an updated prior picture group may be modeled as the following equation 2.

Ratio_{cur}=(Ratioₚᵣₑᵥ*W₁)+(Ratioₚᵣₑᵥ′*W₂) [Equation 2]

Ratio_{cur} of the equation 2 is a bit count ratio value of an updated prior picture group, and this may be used as a bit count ratio value of a current picture group. Ratioₚᵣₑᵥ is a bit count ratio value of a prior picture group, and Ratioₚᵣₑᵥ′ is a ratio of an average bit count of an intra frame and an inter frame used in a prior picture group.

A target bit count calculating unit (127) may obtain a target bit count of a current frame based on the updated bit count ratio value (S450). The target bit count may each be obtained according to a prediction type of a current frame, and for example, may be illustrated as equation 3.

Tᵢₙₜₑᵣ=T_{GOP}/(Iᵢₙₜₑᵣᵥₐₗ+Ratio_{ItoP})

Tᵢₙₜᵣₐ=Tᵢₙₜₑᵣ*Ratio_{ItoP} [Equation 3]

Tᵢₙₜₑᵣ of the equation 3 is an allocated bit count per inter frame, Tᵢₙₜᵣₐ is an allocated bit count per intra frame, T_{GOP} is an allocated bit count per picture group unit, Iᵢₙₜₑᵣᵥₐₗ is a temporal interval of a key frame, Ratio_{ItoP} is a ratio of bit count used in an intra frame and an inter frame in a picture group unit. The key frame may be a frame located temporally in front within a picture group. Also, the key frame may be an intra frame.

Meanwhile, an allocated bit count of the picture group unit may be derived from the following equation 4.

T_{GOP}=Iᵢₙₜₑᵣᵥₐₗ*(T_{sec}/fps) [Equation 4]

T is a target bitrate per seconds, and fps is a frame per second in the equation 4.

A method and an apparatus for controlling video bitrate in frame units is described in the present specification, but is not limited to this, and video bitrate may be controlled in slice units or macro units with the same method.

Meanwhile, the described bitrate control method may be written with computer programming. Codes and code segments comprising the program may be easily inferred by computer programmers in the art. Also, the program may be stored in a computer readable media, which computers may read, and bitrate control may be realized by being read and executed by a computer. The computer readable media may comprise magnetic recording media, optical recording media, and carrier wave media.

The terms and vocabulary used in the specification and claims of the present invention should not be interpreted as limited to its general or its literal meaning, and should be interpreted as definition and concepts corresponding to the technical idea of the present invention based on the principle that an inventor may appropriately define the notion of terms to describe the invention in the best way possible.

Therefore, exemplary embodiments and configuration illustrated in the drawings described herein are only one of the preferred embodiments and does not represent all of the technical idea of the present invention, and it should be understood that various modifications, variations and alterations can be made without deuniting from the scope.

What is claimed is:

1. A method for controlling video bitrate comprising:
receiving a pixel value of a current frame in a current picture group from a video signal;
discrete cosine transforming the pixel value of a current frame;
calculating a complexity of a current frame based on a transform coefficient value of a current frame according to the discrete cosine transform; and
obtaining a quantization parameter of a current frame using the complexity of a current frame.

2. A method for controlling video bitrate according to claim 1, wherein the complexity of a current frame is expressed by a number of alternating components in the transform coefficient value.

3. A method for controlling video bitrate according to claim 1, wherein the discrete cosine transform is performed corresponding to at least one block in a current frame.

4. A method for controlling video bitrate according to claim 1, wherein the discrete cosine transform is performed taking a prediction type of a current frame into consideration, and the prediction type of a current frame is information whether a current frame is an intra frame or an inter frame.

5. A method for controlling video bitrate according to claim 1, wherein the obtaining quantization parameter of a current frame step further comprises obtaining a target bit count of a current frame, and the target bit count of a current frame is obtained based on a bit count ratio value of an updated prior picture group by using a target bit count of a prior frame, and the prior frame is a frame associated with the prior picture group, and the bit count ratio value is a ratio of bit counts used in an intra frame and an inter frame in a picture group unit.

6. A method for controlling video bitrate according to claim 5, wherein the obtaining target bit count of a current frame step further comprises:
obtaining the target bit count of a prior frame;
obtaining a quantization parameter of a prior frame corresponding to the target bit count of a prior frame;
generating a bit count used in a prior frame by encoding the prior frame based on the quatization parameter of a prior frame; and
updating the bit count ratio value of a prior picture group by using the generated bit count and the target bit count of a prior frame.

7. A method for controlling video bitrate according to claim 6, wherein a target bit count of a prior frame temporally closest to the current frame is used when a prediction type of the prior frame and the current frame is same and there are multiple prior frames with a same prediction type of a current frame in a prior picture group.

8. An apparatus for controlling video bitrate comprising:
a second transform unit receiving a pixel value of a current frame in a current picture group from a video signal and discrete cosine transforming the pixel value of a current frame;
a complexity calculating unit calculating complexity of a current frame based on a transform coefficient value of a current frame according to the discrete cosine transform; and
a quantization parameter obtaining unit obtaining a quantization parameter of a current frame using the complexity of a current frame.

9. An apparatus for controlling video bitrate according to claim 8, wherein the complexity of a current frame is expressed by a number of alternating components in the transform coefficient value.

10. An apparatus for controlling video bitrate according to claim 8, wherein the second transform unit performs the discrete cosine transform corresponding to at least on block in a current frame.

11. An apparatus for controlling video bitrate according to claim 8, wherein the second transform unit performs the discrete cosine transform taking a prediction type of a current frame into consideration, and the prediction type of a current frame is information whether a current frame is an intra frame or an inter frame.

12. An apparatus for controlling video bitrate according to claim 8, wherein an apparatus for controlling video bitrate further comprises a target bit count calculating unit obtaining a target bit count of a current frame, and the target bit count of a current frame is obtained based on a bit count ratio value of an updated prior picture group by using a target bit count of a prior frame, and the prior frame is a frame associated with the prior picture group, and the bit count ratio value is a ratio of bit counts used in an intra frame and an inter frame in a picture group unit.

13. An apparatus for controlling video bitrate according to claim 12, wherein the target bit count calculating unit obtains the target bit count of a prior frame, obtains a quantization parameter of a prior frame corresponding to the target bit count of a prior frame, generates a bit count used in a prior frame by encoding the prior frame based on the quantization parameter of a prior frame, and updates the bit count ratio value of a prior picture group by using the generated bit count and the target bit count of a prior frame.

14. An apparatus for controlling video bitrate according to claim 13, wherein a target bit count of a prior frame temporally closest to the current frame is used when a prediction type of the prior frame and the current frame is same and there are multiple prior frames with a same prediction type of a current frame in a prior picture group.
